(19) United States
(12) Patent Application Publication
(10) Pub. No.: US 2014/0180682 A1
(43) Pub. Date: Jun. 26, 2014

(54) NOISE DETECTION DEVICE, NOISE DETECTION METHOD, AND PROGRAM

(71) Applicant: Sony Corporation, Tokyo (JP)

(72) Inventors: Runyu Shi, Tokyo (JP); Hiroyuki Honma, Chiba (JP); Yuki Yamamoto, Tokyo (JP); Toru Chinen, Kanagawa (JP)

(73) Assignee: Sony Corporation, Tokyo (JP)

(21) Appl. No.: 14/104,828

(22) Filed: Dec. 12, 2013

(30) Foreign Application Priority Data
Dec. 21, 2012 (JP) 2012-279013

(51) Int. Cl. G10L 21/0264

(52) U.S. Cl. CPC G10L 21/0264
USPC 704/207

(57) ABSTRACT

There is provided a noise detection device including an amplitude feature quantity calculator, a frequency feature quantity calculator, a feature variation calculator, an interval specification unit, a feature quantity set generation unit, and a noise determination unit.

### CROSS REFERENCE TO RELATED APPLICATIONS

This application claims the benefit of Japanese Priority Patent Application JP 2012-279013 filed Dec. 21, 2012, the entire contents of which are incorporated herein by reference.

### BACKGROUND

The present technology relates to a noise detection device, a noise detection method, and a program, and more particularly, to a noise detection device, a noise detection method, and a program capable of detecting various sudden noises without an increase in a processing load of the device.

Recorders such as IC recorders, smartphones, and video cameras record surrounding voices by a small microphone embedded therein.

When such recorders perform recording, an operation sound occurring when a user operates the recorder by using an operation button or the like, a keyboard operation sound occurring at a position separated from the recorder, and the like are incorporated as noise in the recorded voice.

Therefore, technologies for detecting and reducing special noise, such as a keyboard operation sound occurring at a separated position, that is incorporated as noise while recording have been suggested (for example, see Japanese Unexamined Patent Application Publication No. 2012-027186).

In the noise detection method of Japanese Unexamined Patent Application Publication No. 2012-027186, a detection target is mainly a keyboard operation sound occurring at a position separated from a recorder.

Generally, the keyboard operation sound appears as a set of a pulse-like noise signal having a relatively long duration on a recorded voice signal. Therefore, noise caused due to the operation sound can be easily detected by comparing a threshold value with an amplitude value (signal level) of pulse-like noise signals having a relatively long duration, or comparing a threshold value with a high-frequency band component which the voice signal rarely has.

Technologies for determining whether an input signal is a voice (for example, conversation) or a non-voice (for example, see Japanese Unexamined Patent Application Publication No. 2009-251134) have been suggested. For example, a frame that is determined as a non-voice using the technology of Japanese Unexamined Patent Application Publication No. 2009-251134 can be recognized as noise.

### SUMMARY

However, the noise recorded by a recorder includes not only signals such as a keyboard operation sound having a frequency feature similar to that of a pulse signal, but also many sudden noises such as many people's loud laughter and a rubbing sound having a special frequency feature. Such noises are not easily detected by, for example, the related art of Japanese Unexamined Patent Application Publication No. 2012-027186.

In addition, most sudden noises (for example, prolonged applause, cough, and sneeze) recorded by a recorder have an unstable duration, and thus have a value that has a large dispersion and can rarely be predicted. Therefore, it is also difficult to detect the noises by the detection method using an attenuation feature quantity, which is a noise detection method according to the technology of Japanese Unexamined Patent Application Publication No. 2012-027186.

Furthermore, in the detection method using an attenuation feature quantity as in the technology of Japanese Unexamined Patent Application Publication No. 2012-027186, the signal is analyzed in a relatively long time range, and thus there is a problem in that delay corresponding to the time range is caused.

The technology of Japanese Unexamined Patent Application Publication No. 2009-251134 is a method of merely judging whether an input signal is a voice, and is not intended to detect noise. For example, even when noise is detected using the technology of Japanese Unexamined Patent Application Publication No. 2009-251134, it may be difficult to judge whether the noise is sudden noise.

In addition, in the method disclosed in Japanese Unexamined Patent Application Publication No. 2009-251134, the calculation may be considered to be complicated. For example, mounting on mobile devices may be difficult.

It is desirable to detect various sudden noises without an increase in a processing load of the device.

According to an embodiment of the present technology, there is provided a noise detection device including an amplitude feature quantity calculator that calculates an amplitude feature quantity in a waveform of a predetermined frame of an input signal of a voice, a frequency feature quantity calculator that calculates a frequency feature quantity in the waveform of the predetermined frame, a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames, an interval specification unit that compares the feature variation with a previously set threshold value to specify an interval of temporarily continuous frames in which the amplitude feature quantities and the frequency feature quantities held in the holding unit are to be subjected to weighted averaging, a feature quantity set generation unit that generates, as a feature quantity set, a set of respective weighted average values of the amplitude feature quantities and the frequency feature quantities corresponding to each of the frames of the specified interval, and a noise determination unit that determines whether a latest frame of the input signal is a frame including non-stationary noise that is sudden noise based on the feature quantity set.

The amplitude feature quantity calculator or the frequency feature quantity calculator may calculate at least two types of amplitude feature quantities among a plurality of types of amplitude feature quantities or a plurality of types of frequency feature quantities. A feature quantity selection unit that selects an amplitude feature quantity to be calculated by the amplitude feature quantity calculator among the plurality of types of amplitude feature quantities, or a frequency feature quantity to be calculated by the frequency feature quantity calculator among the plurality of types of frequency feature quantities, based on a zero crossing rate of the input signal of the predetermined frame, an average value of a plurality of sample values of the input signal of the predetermined frame, or an RMS value of the plurality of sample values of the input signal of the predetermined frame, may be further provided.

The feature quantity selection unit may determine whether the input signal of the predetermined frame is closer to a vowel or a consonant based on the zero crossing rate of the input signal of the predetermined frame, and selects, in accordance with the determination result, the amplitude feature quantity to be calculated by the amplitude feature quantity calculator and the frequency feature quantity to be calculated by the frequency feature quantity calculator among the plurality of types of frequency feature quantities.

The amplitude feature quantity calculator may calculate, as the amplitude feature quantity, at least one of a peak value of a plurality of sample values of the predetermined frame, an average value of the plurality of sample values of the predetermined frame, and an RMS value of the plurality of sample values of the predetermined frame. The frequency feature quantity calculator may calculate, as the frequency feature quantity, at least one of a zero crossing rate of the input signal of the predetermined frame, a ratio of a sound pressure of a specific frequency component to sound pressures of all of frequency components in the input signal of the predetermined frame, a ratio of the sound pressure of the specific frequency component to a sound pressure of a frequency component differing from the specific frequency component in the input signal of the predetermined frame, and one or more specific values among frequency spectra obtained by a Fourier transform of the input signal of the predetermined frame.

The noise determination unit may calculate a ratio of a weighted average value of the amplitude feature quantities included in the feature quantity set and a previously set first value, and a ratio of a weighted average value of the frequency feature quantities and a previously set second value, calculates a noise likelihood based on the calculated ratios, and compares the noise likelihood with a previously set threshold value to determine whether the latest frame of the input signal is a frame including the non-stationary noise.

The noise determination unit may calculate a noise likelihood, representing certainty of a determination that a present frame is a non-stationary noise frame, from a feature vector corresponding to the feature quantity set based on a previously learned identification model in a feature vector space using some or all of the weighted average values of the amplitude feature quantities and the weighted average values of the frequency feature quantities included in the feature quantity set, and compares the noise likelihood with a previously set threshold value to determine whether the latest frame of the input signal is a frame including the non-stationary noise.

The noise detection device may further include a frequency feature corrector that corrects a frequency feature of a signal input device that supplies the input signal.

The noise detection device may further include a stationary noise removing unit that removes, from the input signal, stationary noise that is noise differing from the non-stationary noise.

According to an embodiment of the present technology, there is provided a noise detection method including calculating, by an amplitude feature quantity calculator, an amplitude feature quantity in a waveform of a predetermined frame of an input signal of a voice; calculating, by a frequency feature quantity calculator, a frequency feature quantity in the waveform of the predetermined frame; calculating, by a feature variation calculator, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames; comparing, by an interval specification unit, the feature variation with a previously set threshold value to specify an interval of temporarily continuous frames in which the amplitude feature quantities and the frequency feature quantities held in the holding unit are to be subjected to weighted averaging; generating, by a feature quantity set generation unit, as a feature quantity set, a set of respective weighted average values of the amplitude feature quantities and the frequency feature quantities corresponding to each of the frames of the specified interval; and determining, by a noise determination unit, whether a latest frame of the input signal is a frame including non-stationary noise that is sudden noise based on the feature quantity set.

According to an embodiment of the present technology, there is provided a program causing a computer to function as a noise detection device including an amplitude feature quantity calculator that calculates an amplitude feature quantity in a waveform of a predetermined frame of an input signal of a voice, a frequency feature quantity calculator that calculates a frequency feature quantity in the waveform of the predetermined frame, a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames, an interval specification unit that compares the feature variation with a previously set threshold value to specify an interval of temporarily continuous frames in which the amplitude feature quantities and the frequency feature quantities held in the holding unit are to be subjected to weighted averaging, a feature quantity set generation unit that generates, as a feature quantity set, a set of respective weighted average values of the amplitude feature quantities and the frequency feature quantities corresponding to each of the frames of the specified interval, and a noise determination unit that determines whether a latest frame of the input signal is a frame including non-stationary noise that is sudden noise based on the feature quantity set.

In an embodiment of the present technology, an amplitude feature quantity in a waveform of a predetermined frame of an input signal of a voice is calculated; a frequency feature quantity in the waveform of the predetermined frame is calculated; based on any one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames is calculated; the feature variation is compared with a previously set threshold value to specify an interval of temporarily continuous frames in which the amplitude feature quantities and the frequency feature quantities held in the holding unit are to be subjected to weighted averaging; as a feature quantity set, a set of respective weighted averages of the amplitude feature quantities and the frequency feature quantities corresponding to each of the frames of the specified interval is generated; and whether the latest frame of the input signal is a frame including non-stationary noise that is sudden noise is determined based on the feature quantity set.

According to an embodiment of the present technology, it is possible to detect various sudden noises without an increase in a processing load of the device.

### BRIEF DESCRIPTION OF THE DRAWINGS

FIG. 1 is a block diagram illustrating an example of a configuration of a noise detection device according to an embodiment of the present technology;

FIG. 2 is a diagram illustrating the relationship between a curve of frequency feature a signal input unit and a linear average of frequency feature;

FIG. 3 is a block diagram illustrating a detailed example of a configuration of the frame integration unit of FIG. 1;

FIG. 4 is a diagram illustrating a waveform of an input signal, a waveform showing a variation in the amplitude feature quantity, and a waveform showing a variation in the feature variation;

FIG. 5 is a flowchart for describing an example of a noise detection process of the noise detection device of FIG. 1;

FIG. 6 is a flowchart for describing a detailed example of the integration process of FIG. 5;

FIG. 7 is a block diagram illustrating an example of a configuration according to another embodiment of the noise detection device to which the present technology is applied;

FIG. 8 is a block diagram illustrating a detailed example of a configuration of the feature quantity selection unit of FIG. 7;

FIG. 9 is a diagram illustrating an example of the comparison in the frequency feature between a cough and a vowel and between a cough and a consonant;

FIG. 10 is a diagram illustrating an example of a distribution of zero crossing rates of voice signals;

FIG. 11 is a block diagram illustrating an example of a configuration according to a further embodiment of the noise detection device to which the present technology is applied; and

FIG. 12 is a block diagram illustrating an example of a configuration of a personal computer.

### DETAILED DESCRIPTION OF THE EMBODIMENTS

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

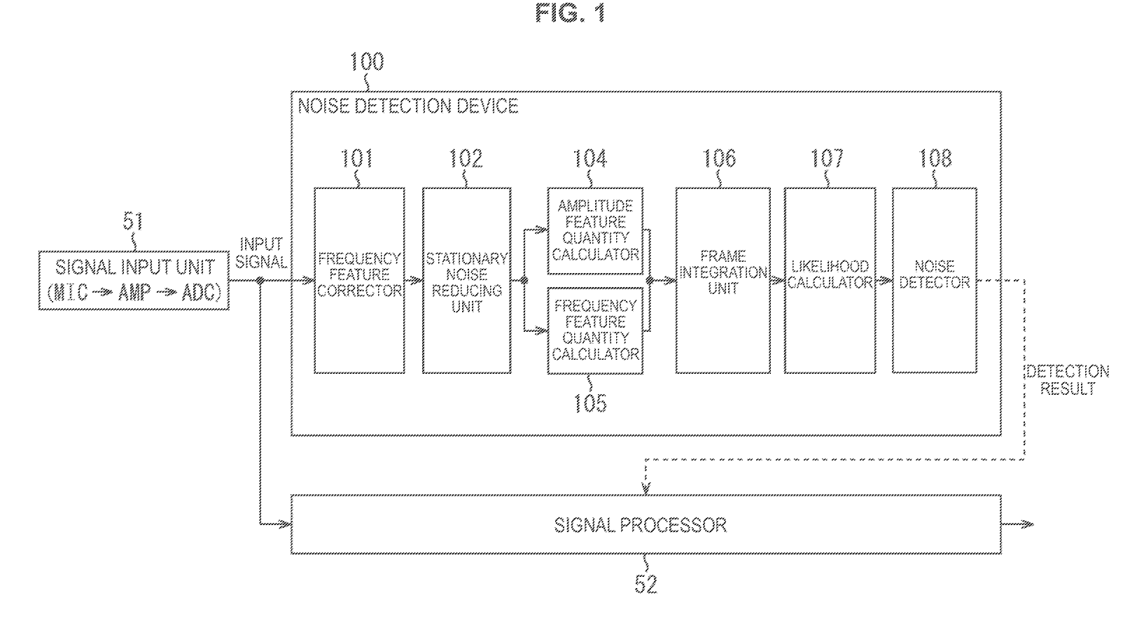

FIG. 1 is a block diagram illustrating an example of a configuration of a noise detection device according to an embodiment of the present technology. A noise detection device 100 illustrated in FIG. 1 is configured to detect sudden noise (also referred to as non-stationary noise) included in surrounding voices. Here, the sudden noise is a sound such as prolonged applause, a cough, and a sneeze.

As illustrated in FIG. 1, the noise detection device 100 includes a frequency feature corrector 101, a stationary noise reducing unit 102, an amplitude feature quantity calculator 104, a frequency feature quantity calculator 105, a frame integration unit 106, a likelihood calculator 107, and a noise detector 108.

In addition, a signal input unit 51 and a signal processor 52 are connected to the noise detection device 100.

The signal input unit 51 includes a sound collecting microphone that collects surrounding voices, an amplifier that amplifies a voice signal input from the microphone with an amplification factor given from a main controller, and an AD converter that converts an analog signal supplied from the amplifier into a digital signal.

In recent years, modules in which an amplifier and an AD converter (a DA converter may be included) are formed integrally with each other have been in widespread use, and such a module may be provided in the signal input unit 51. In addition, the signal input unit 51 may function to directly read a digital voice signal from a recording medium (for example, a hard disk, a CD, a semiconductor memory, and the like).

The frequency feature corrector 101 includes, for example, a filter interpolating a unique frequency feature F_{id}(n) of the signal input unit 51. That is, in order to prevent a digital signal supplied from the signal input unit 51 from being influenced by the unique frequency feature of the signal input unit 51, the above-described filter removes the influence of the unique frequency feature of the signal input unit 51 from the input signal. The process of the frequency feature corrector 101 will be described later in detail.

The frequency feature corrector 101 supplies the signal from which the influence of the unique frequency feature of the signal input unit 51 has been removed to the stationary noise reducing unit.

In the stationary noise reducing unit 102, a level of stationary noise is calculated. Here, the stationary noise means noise in which the frequency feature and the amplitude feature included in a digital signal do not change in a long time interval. Examples of the stationary noise include a driving sound of the noise detection device 100, the signal input unit 51, or the signal processor 52, and an air conditioning sound in a conference room.

In the stationary noise reducing unit 102, a stationary noise component at a calculated level is removed from the input signal, and then supplied to the amplitude feature quantity calculator 104 and the frequency feature quantity calculator 105. For example, a noise reduction method that is commonly used or another method may be employed to reduce stationary noise.

In the amplitude feature quantity calculator 104, one or more amplitude feature quantities are calculated from the input signal supplied from the stationary noise reducing unit 102 and are supplied to the frame integration unit 106. The amplitude feature quantity will be described later in detail.

In the frequency feature quantity calculator 105, one or more frequency feature quantities are calculated from the input signal supplied from the stationary noise reducing unit 102 and are supplied to the frame integration unit 106. The frequency feature quantity will be described later in detail.

In the frame integration unit 106, the amplitude feature quantity and the frequency feature quantity, which are calculated for each frame and supplied from the amplitude feature quantity calculator 104 and the frequency feature quantity calculator 105, respectively, are collected for a predetermined number of frames and integrated as one feature quantity set F_pack. The integration method will be described later in detail. The feature quantity set F_pack is supplied to the likelihood calculator 107.

The likelihood calculator 107 calculates a ratio of a preset threshold value to each feature quantity included in the feature quantity set F_pack integrated by the frame integration unit 106. In addition, the likelihood calculator 107 estimates noise likelihood for each of the feature quantities of the feature quantity set F_pack based on the calculated ratio and calculates, as noise likelihood of the input signal, a weighted average value of the estimated noise likelihood for each of the feature quantities. The calculated noise likelihood is supplied to the noise detector 108. The method of calculating the noise likelihood will be described later in detail.

The noise detector 108 compares the noise likelihood of the input signal supplied from the likelihood calculator 107 with a preset threshold value and determines whether the input signal is non-stationary noise. The result of the determination by the noise detector 108 is output to the signal processor 52 as a final detection result obtained by the noise detection device 100.

The signal processor 52 performs a signal process using the detection result output from the noise detector 108. In addition, the signal processor 52 includes a recording unit that records a voice signal as necessary to record a voice signal in a recording medium such as a hard disk, a CD, or a semiconductor memory.

Specifically, in the signal processor 52, for example, the detection result output from the noise detector 108 is used to calculate a recording sensitivity adapted only for the voice part of the input signal. For example, a recording sensitivity suitable for recording a voice excluding noise from a surrounding voice including the noise is calculated.

In addition, in the signal processor 52, an adaptive process is performed using the detection result output from the noise detector 108. For example, in the signal processor 52, a noise reduction process is performed using the detection result.

Otherwise, in the signal processor 52, the detection result may be used to know a noise type (cough, sneeze, laughter, and the like), and a recording environment of the input signal may be estimated from the noise type to feed the information back. For example, when the noise type is a cough, information indicating that a person in the recording environment is in a poor state of health may be fed back, when the noise type is a sneeze, information indicating that the air in that location is not clear may be fed back. When the noise type is laughter, information indicating that a funny comment has been made may be fed back.

Next, the process of the frequency feature corrector 101 will be described in detail. The frequency feature corrector 101 acquires an input signal S(n) corresponding to a frame n from the signal input unit 51. Here, the input signal S(n) is defined as shown in Expression (1).

S(n)=sig(L·n+i),(i=1 . . . L) (1)

In Expression (1), L is a sample value that is obtained as a result of sampling in the A/D conversion, and represents the number of sample values included in one frame. A set of sample values included in an n-th frame is obtained through Expression (1).

The frequency feature corrector 101 generates a filter H_{id} to correct a unique frequency feature F_{id}(n) based on the unique frequency feature F_{id}(n) of the signal input unit 51, which has been obtained by previous measurement, and processes the input signal S(n) by the filter H_{id} to perform correction of removing the unique frequency feature F_{id}(n) from the input signal S(n).

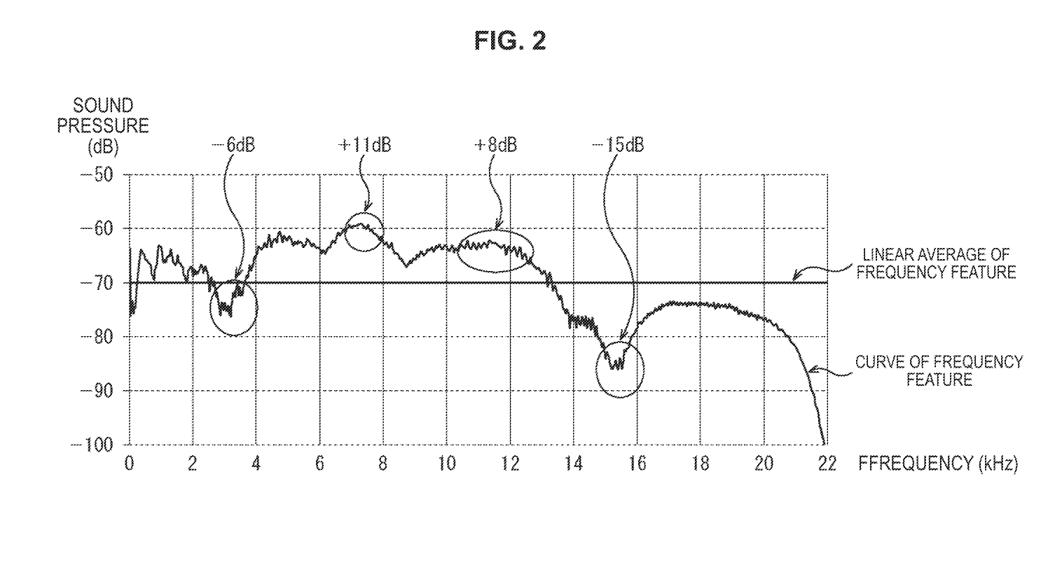

FIG. 2 is a diagram illustrating the relationship between a curve of frequency feature representing the unique frequency feature of the signal input unit 51 and a linear average of frequency feature that is an ideal frequency feature with a horizontal axis representing sound pressure and a vertical axis representing frequency. As illustrated in FIG. 2, the curve of frequency feature differs from the linear average of frequency feature by −6 dB, +11 dB, +8 dB, and −15 dB in the vicinities of frequencies of 3 kHz, 7 kHz, 11 kHz, and 15 kHz, respectively. In this case, by generating H_{id} for correction by +6 dB, −11 dB, −8 dB, and +15 dB in the vicinities of frequencies of 3 kHz, 7 kHz, 11 kHz, and 15 kHz, respectively, it is possible to perform correction of removing the unique frequency feature F_{id}(n) from the input signal S(n).

In the vicinities of frequencies of 3 kHz, 7 kHz, 11 kHz, and 15 kHz extracted in FIG. 2, for example, the sound pressure is most separated from the linear average of frequency feature, and the frequencies are selected as frequencies to be corrected.

Otherwise, the frequency feature corrector 101 may generate a mapping table corresponding to the unique frequency feature F_{id}(n) of the signal input unit 51, and supply the mapping table to the amplitude feature quantity calculator 104 and the frequency feature quantity calculator 105 upon calculation of the amplitude feature quantity and calculation of the frequency feature quantity to be described later. For example, information indicating that a sound pressure is applied by +6 dB, −11 dB, −8 dB, and +15 dB in the vicinities of frequencies of 3 kHz, 7 kHz, 11 kHz, and 15 kHz, respectively, is converted into a mapping table and supplied to the amplitude feature quantity calculator 104 and the frequency feature quantity calculator 105.

In the stationary noise reducing unit 102, a mapping table may also be created in the same manner as in the frequency feature corrector 101 to reduce stationary noise.

Next, the amplitude feature quantity will be described in detail.

The amplitude feature quantity calculator 104 analyzes the amplitude feature of the input signal S(n) to calculate an amplitude feature quantity representing the amplitude feature of the frame n. Here, E₁(n), E₂(n), and E₃(n) are calculated as amplitude feature quantities of the frame n.

E₁(n) is an amplitude feature quantity representing a peak value of L sample values included in the frame n, and is calculated through Expression (2).

$${E}_{1} ( n ) = pk ( n ) = {max}_{1 \leq i \leq L} \vert sig ( L \cdot n + i ) \vert \qquad ( 2 )$$

E₂(n) is an amplitude feature quantity representing an average value of the L sample values included in the frame n, and is calculated through Expression (3).

$${E}_{2} ( n ) = avg ( n ) = \frac{1}{L} {\sum }_{i = 1}^{L} \vert sig ( L \cdot n + i ) \vert \qquad ( 3 )$$

E₃(n) is an amplitude feature quantity representing a root means square (RMS) value of the L sample values included in the frame n, and is calculated through Expression (4).

$${E}_{3} ( n ) = rms ( n ) = \sqrt{\frac{1}{L} {\sum }_{i = 1}^{L} {sig ( L \cdot n + i )}^{2}} \qquad ( 4 )$$

Expressions (3) and (4) show examples of the calculation of a linear average of sample values. However, for example, a logarithmic average of the sample values, or a value obtained by weighting and adding a linear average and a logarithmic average of the sample values may be used.

Furthermore, before the calculation of E₁(n), E₂(n), and E₃(n), the input signal S(n) may be processed by a high-pass filter to remove noise of a DC component included in the input signal.

An amplitude feature quantity other than the above-described E₁(n), E₂(n), and E₃(n) may be calculated.

Next, the frequency feature quantity will be described in detail.

The frequency feature quantity calculator 105 analyzes the frequency feature of the input signal S(n) to calculate a frequency feature quantity representing the frequency feature of the frame n. Here, F₁(n), F₂(n), F₃(n), and F₄(n) are calculated as frequency feature quantities of the frame n.

F₁(n) is a feature quantity representing a zero crossing rate of the input signal, and is calculated through Expression (5).

$${F}_{1} ( n ) = zcr ( n ) = \frac{{\sum }_{i = 1}^{L - 1} symbol ( i )}{L - 1} \qquad ( 5 )$$

In Expression (5), the symbol (i) is expressed by Expression (6).

$$symbol ( i ) = \{ \begin{matrix}1 , & sig ( L \cdot n + i + 1 ) \cdot sig ( L \cdot n + i ) > 0 \\ 0 , & sig ( L \cdot n + i + 1 ) \cdot sig ( L \cdot n + i ) \leq 0\end{matrix} \qquad ( 6 )$$

F₂(n) is a feature quantity representing a ratio of a sound pressure of a specific frequency component to sound pressures of all of frequency components in the input signal, and is calculated through Expression (7).

$$\begin{matrix}{F}_{2} ( n ) = \{ \frac{bpf {1}_{rms} ( n )}{{E}_{3} ( n )} , \frac{bpf {2}_{rms} ( n )}{{E}_{3} ( n )} , … \} \\ = \{ \frac{\sqrt{\frac{1}{L} {\sum }_{i = 1}^{L} {{sig}_{bpf\_ 1} ( L \cdot n + i )}^{2}}}{\sqrt{\frac{1}{L} {\sum }_{i = 1}^{L} {sig ( L \cdot n + i )}^{2}}} , \frac{\sqrt{\frac{1}{L} {\sum }_{i = 1}^{L} {{sig}_{bpf\_ 2} ( L \cdot n + i )}^{2}}}{\sqrt{\frac{1}{L} {\sum }_{i = 1}^{L} {sig ( L \cdot n + i )}^{2}}}\end{matrix} \qquad ( 7 )$$

In Expression (7), E₃(n) is E₃(n) calculated through Expression (4).

In addition, Sig_{bpf}_{_{—}}₁(i), Sig_{bpf}_{_{—}}₂(i), and so on shown in Expression (7) are calculated through Expression (8).

$${sig}_{bpf\_m} ( i ) = {\sum }_{h = 0}^{p - 1} {F}_{bpf\_m} ( h ) \cdot sig ( i - h ) \qquad ( 8 )$$

In Expression (8), F_{bpf}_{_{—}}ₘ(h) represents a coefficient of a filter for extracting an m-th frequency component.

F₃(n) is a feature quantity representing a ratio of a sound pressure of a specific frequency component to a sound pressure of a frequency component differing from the specific frequency component in the input signal, and is calculated through Expression (9).

$${F}_{3} ( n ) = \{ \frac{{bpf}_{a 1 \_rms} ( n )}{{bpf}_{b 1 \_rms} ( n )} , \frac{{bpf}_{a 2 \_rms} ( n )}{{bpf}_{b 2 \_rms} ( n )} , … \} \qquad ( 9 )$$

Each of bpfₐ₁_{_{—}}ᵣₘₛ(n), bpfₐ₂_{_{—}}ᵣₘₛ(n), bpf_{b1}_{_{—}}ᵣₘₛ(n), bpf_{b2}_{_{—}}ᵣₘₛ(n), and so on shown in Expression (9) is calculated in the same manner as in the cases of bpf1ᵣₘₛ(n), bpf2ᵣₘₛ(n), and so on shown as molecules in Expression (7). However, when bpfₐ₁_{_{—}}ᵣₘₛ(n), bpfₐ₂_{_{—}}ᵣₘₛ(n), bpf_{b1}_{_{—}}ᵣₘₛ(n), bpf_{b2}_{_{—}}ᵣₘₛ(n), and so on are calculated, F_{bpf}_{_{—}}ₘ(h) corresponding to each of the frequency components thereof is used.

F₄(n) is a feature quantity formed of one or more specific values among frequency spectra obtained by a Fourier transform of the input signal, and is calculated through Expression (10).

F₄(n)=FFT(S(n)) (10)

Before the calculation of F₁(n), F₂(n), F₃(n), and F₄(n), the input signal S(n) may be processed by a high-pass filter to remove noise of a DC component included in the input signal.

Here, the case in which the amplitude feature quantity calculator 104 calculates E₁(n), E₂(n), and E₃(n), and the frequency feature quantity calculator 105 calculates F₁(n), F₂(n), F₃(n), and F₄(n) has been described. However, the amplitude feature quantity calculator 104 may calculate one or two of E₁(n), E₂(n), and E₃(n), and the frequency feature quantity calculator 105 may calculate one to three of F₁(n), F₂(n), F₃(n), and F₄(n).

A frequency feature quantity other than the above-described F₁(n), F₂(n), F₃(n), and F₄(n) may be calculated.

Next, the integrating method of the frame integration unit 106 will be described in detail.

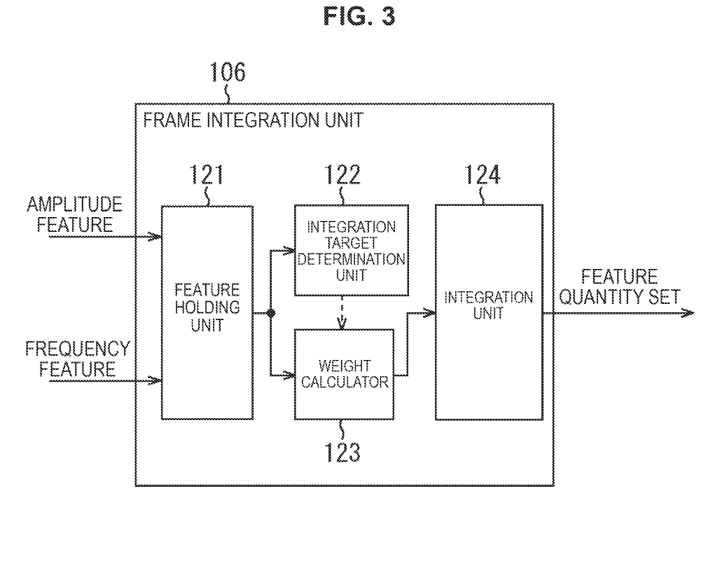

FIG. 3 is a diagram illustrating a detailed example of a configuration of the frame integration unit 106. As illustrated in FIG. 3, the frame integration unit 106 includes a feature holding unit 121, an integration target determination unit 122, a weight calculator 123, and an integration unit 124.

The feature holding unit 121 holds the amplitude feature quantities and the frequency feature quantities of a predetermined number of past frames (for example, a frames), supplied from the amplitude feature quantity calculator 104 and the frequency feature quantity calculator 105, respectively.

The integration target determination unit 122 determines an integration target frame as follows using the amplitude feature quantity or the frequency feature quantity held in the feature holding unit 121.

The integration target determination unit 122 calculates a feature variation F_{d—}diff representing a variation in the feature quantity between frames of the feature quantity using any one feature quantity F_{d} among the amplitude feature quantities and the frequency feature quantities held in the feature holding unit 121.

For example, when the feature holding unit 121 holds E₁(n), E₂(n), E₃(n), F₁(n), F₂(n), F₃(n), and F₄(n), a feature variation F_{d—}diff representing a variation between an amplitude feature quantity E₃(i−1) of an i−1-th frame and an amplitude feature quantity E₃(i) of an i-th frame is calculated using E₃(n).

The feature variation F_{d—}diff is calculated through Expression (11).

$${F}_{d} \_diff ( i ) = \frac{\vert {F}_{d} ( i ) - {F}_{d} ( i - 1 ) \vert}{min ( {F}_{d} ( i ) , {F}_{d} ( i - 1 ) )} , \qquad ( 11 )$$

The integration target determination unit 122 sequentially calculates a feature variation between the respective frames using the feature quantities of all of the frames held in the feature holding unit 121. Each of the calculated feature variations is compared with a previously set threshold value F_{d—}diff_th. In the past frames, a frame in which the feature variation F_{d—}diff initially exceeds the threshold value F_{d—}diff_th is set as an integration target start frame, and amplitude feature quantities and frequency feature quantities of frames (for example, b frames) from the integration target start frame to a current frame n are determined as integration targets. This determination result is supplied to the weight calculator 123.

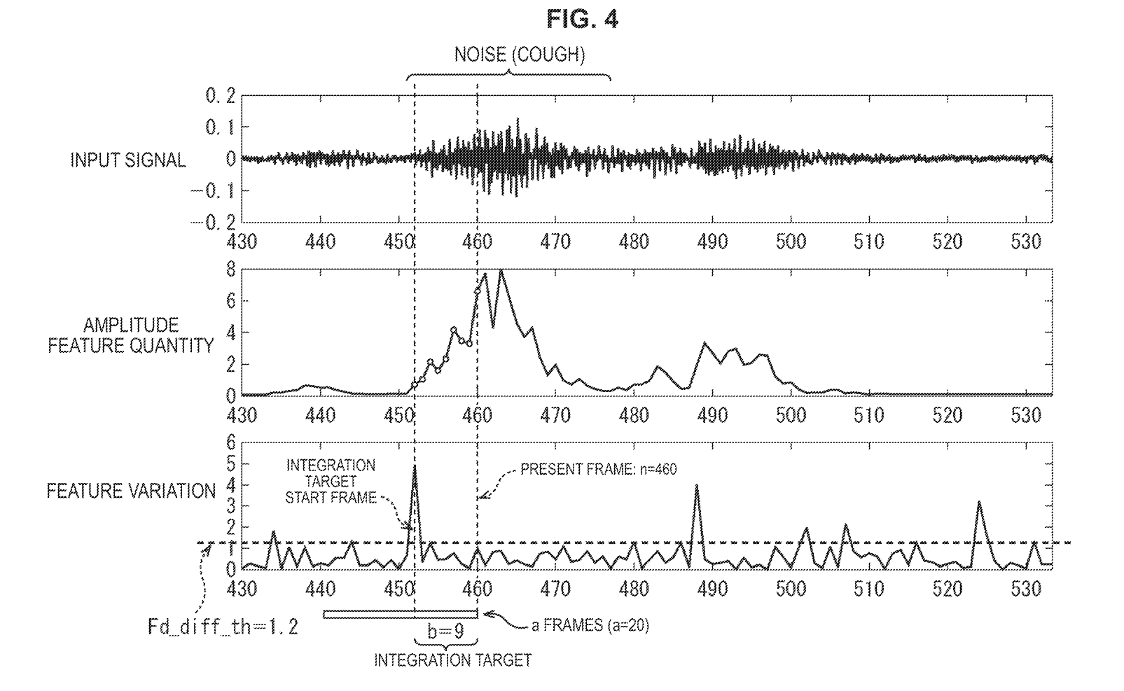

A more detailed description will be made with reference to FIG. 4. In FIG. 4, a horizontal axis represents a frame, and a waveform of the input signal, a waveform showing a variation in the amplitude feature quantity calculated from the input signal, and a waveform showing a variation in the feature variation calculated based on the amplitude feature quantity are illustrated in order from above. FIG. 4 is based on the assumption that, for example, a cough sound is incorporated in voices during a conference.

A 460^{th} frame is set as a current frame, and the feature holding unit 121 holds amplitude feature quantities and frequency feature quantities of 20 frames, i.e., 441^{st} to 460^{th} frames.

In the example of FIG. 4, in the amplitude feature quantities of the 20 frames, a feature variation corresponding to the 452^{nd} frame initially exceeds the threshold value F_{d—}diff_th (=1.2). Accordingly, the 452^{nd} frame is set as an integration target start frame, and 9 frames up to the 460^{th} frame are determined as integration targets.

Thus, the integration target frames are determined.

Using a feature quantity F_{w} among the feature quantities held in the feature holding unit 121, the weight calculator 123 calculates a weight based on a difference or a ratio between a feature quantity F_{w} of the current frame and a feature quantity F_{w} of another frame that is an integration target. A weight W(i) of the i-th frame is calculated through Expression (12) or (13).

$$\begin{matrix}W ( i ) = \frac{{F}_{W} ( n ) - {F}_{W} ( i )}{{F}_{W} ( n )} , & ( 12 ) \\ W ( i ) = \frac{{F}_{W} ( i )}{{F}_{W} ( n )} , & ( 13 )\end{matrix}$$

Expression (12) is for the case in which the weight is calculated based on a difference between the feature quantity F_{w} of the current frame and the feature quantity F_{w} of another frame that is an integration target, and Expression (13) is for the case in which the weight is calculated based on a ratio between the feature quantity F_{w} of the current frame and the feature quantity F_{w} of another frame that is an integration target.

The feature quantity F_{w} used by the weight calculator 123 may be the same as or different from the feature quantity F_{d} used by the integration target determination unit 122.

The weight calculated by the weight calculator 123 is supplied to the integration unit 124.

The integration unit 124 calculates a weighted average value E_{S}(n) of the amplitude feature quantities through Expression (14) using the weight supplied from the weight calculator 123.

$${E}_{S} ( n ) = \frac{\begin{matrix}W ( n - b + 1 ) E ( n - b + 1 ) + \\ W ( n - b + 2 ) E ( n - b + 2 ) + … + W ( n ) E ( n )\end{matrix}}{( W ( n - b + 1 ) + W ( n - b + 2 ) + … + W ( n ) ) b} \qquad ( 14 )$$

In Expression (14), n represents a current frame, and b represents the number of integration target frames. In addition, as described above, when the feature holding unit 121 holds a plurality of amplitude feature quantities (for example, E₁(n), E₂(n), and E₃(n)), each of E₁(n), E₂(n), and E₃(n) is set as E(n) in Expression (14), and weighted average values E_{S1}(n) to E_{S3} (n) of the amplitude feature quantities are respectively calculated.

The integration unit 124 calculates a weighted average value F_{S}(n) of the frequency feature quantities through Expression (15) using the weight supplied from the weight calculator 123.

$${F}_{S} ( n ) = \frac{\begin{matrix}W ( n - b + 1 ) F ( n - b + 1 ) + \\ W ( n - b + 2 ) F ( n - b + 2 ) + … + W ( n ) F ( n )\end{matrix}}{( W ( n - b + 1 ) + W ( n - b + 2 ) + … + W ( n ) ) b} \qquad ( 15 )$$

In Expression (15), n represents a current frame, and b represents the number of integration target frames. In addition, as described above, when the feature holding unit 121 holds a plurality of amplitude feature quantities (for example, F₁(n), F₂(n), F₃(n), and F₄(n)), each of F₁(n), F₂(n), F₃(n), and F₄(n) is set as F(n) in Expression (15), and weighted average values F_{S1}(n) to F_{S4}(n) of the frequency feature quantities are respectively calculated.

The integration unit 124 supplies, to the likelihood calculator 107, a set of the weighted average value E_{S}(n) of the amplitude feature quantities and the weighted average value F_{S}(n) of the frequency feature quantities as a feature quantity set F_pack.

The frame integration unit 106 may not include the weight calculator 123, and a set of simple averages of the amplitude feature quantities and the frequency feature quantities of the frames determined as integration targets by the integration target determination unit 122 may be integrated to generate a feature quantity set F_pack in the integration unit 124.

In addition, the frame integration unit 106 may not include the integration target determination unit 122, and the weights of all of the frames held by the feature holding unit 121 may be calculated in the weight calculator 123 to generate a feature quantity set F_pack in which a set of weighted averages of the amplitude feature quantities and the frequency feature quantities of all of the frames is integrated in the integration unit 124.

Furthermore, the frame integration unit 106 may not include the integration target determination unit 122 and the weight calculator 123, and a set of simple average values of the amplitude feature quantities and the frequency feature quantities of all of the frames held by the feature holding unit 121 may be generated as a feature quantity set F_pack in the integration unit 124.

The likelihood calculator 107 calculates a ratio of a preset threshold value to each feature quantity included in the feature quantity set F_pack integrated by the frame integration unit 106.

For example, a threshold value E_th corresponding to the amplitude feature quantity and a threshold value F_th corresponding to the frequency feature quantity are preset.

The likelihood calculator 107 calculates a ratio R_{E}(n) of the threshold value E_th to a weighted average value of the amplitude feature quantities included in the feature quantity set F_pack through Expression (16).

$${R}_{E} ( n ) = \frac{{E}_{S} ( n ) - {E}_{S} \_th}{{E}_{S} ( n )} \qquad ( 16 )$$

In addition, the likelihood calculator 107 calculates a ratio R_{F}(n) of the threshold value F_th to a weighted average value of the frequency feature quantities included in the feature quantity set F_pack through Expression (17).

$${R}_{F} ( n ) = \frac{{F}_{S} ( n ) - {F}_{S} \_th}{{F}_{S} ( n )} \qquad ( 17 )$$

The likelihood calculator 107 multiplies the ratios R_{E}(n) and R_{F}(n) by preset weights A_{E} and A_{E}, respectively, to calculate a weighted sum. The weighted sum is calculated through Expression (18), and is supplied to the noise detector 108 as noise likelihood R(n) corresponding to the n-th frame of the input signal.

R(n)=A_{E}·R_{E}(n)+A_{F}·R_{F}(n) (18)

The noise detector 108 compares the noise likelihood of the input signal supplied from the likelihood calculator 107 with a preset threshold value to determine whether the n-th frame of the input signal is a non-stationary noise frame. For example, when a noise likelihood threshold value R_th for determination of non-stationary noise is preset, and the noise likelihood R(n) is greater than the noise likelihood threshold value R_th, the n-th frame of the input signal is determined to be a non-stationary noise frame. Conversely, when the noise likelihood R(n) is equal to or less than the noise likelihood threshold value R_th, the n-th frame of the input signal is determined not to be a non-stationary noise frame.

Thus, the non-stationary noise is detected. In an embodiment of the present technology, as described above, at least one amplitude feature quantity and at least one frequency feature quantity are used to perform the determination of non-stationary noise. Therefore, it is possible to detect the non-stationary noise with higher accuracy.

In addition, in the frame integration unit 106, since the integration target frame is specified, it is possible to reduce the load of the calculation of the feature quantities included in the feature quantity set F_pack. Therefore, it is possible to mount the noise detection device 100 even in, for example, small power saving-type equipment.

Furthermore, by setting the noise likelihood threshold value as a dedicated noise likelihood threshold value for cough detection, only the cough can be determined as non-stationary noise, and by setting the noise likelihood threshold value as a dedicated noise likelihood threshold value for applause detection, only the applause can be determined as non-stationary noise. Thus, in an embodiment of the present technology, the noise likelihood threshold value is appropriately set, and thus a non-stationary noise type can also be specified.

In the above-described example, the likelihood calculator 107 performs threshold value comparison based on the previously set threshold value E_th corresponding to the amplitude feature quantity and the previously set threshold value F_th corresponding to the frequency feature quantity, and performs calculation of Expressions (16) to (18) to calculate the noise likelihood.

However, for example, the likelihood calculator 107 may calculate a noise likelihood from the feature quantity set F_pack by using a previously learned identification model M. In this case, for example, a Gaussian mixed model (GMM), a hidden Markov model (HMM), a support vector machine (SVM), or the like can be employed as the identification model M.

That is, a feature vector space is generated using some or all of the weighted average values of the amplitude feature quantities and the weighted average values of the frequency feature quantities included in the feature quantity set F_pack. The likelihood calculator 107 calculates, from the feature vector corresponding to the feature quantity set F_pack, a noise likelihood representing certainty of a determination that the present frame is a non-stationary noise frame based on the previously learned identification model in the feature vector space.

These likelihood calculation methods using an identification model are similar to those that have been commonly employed.

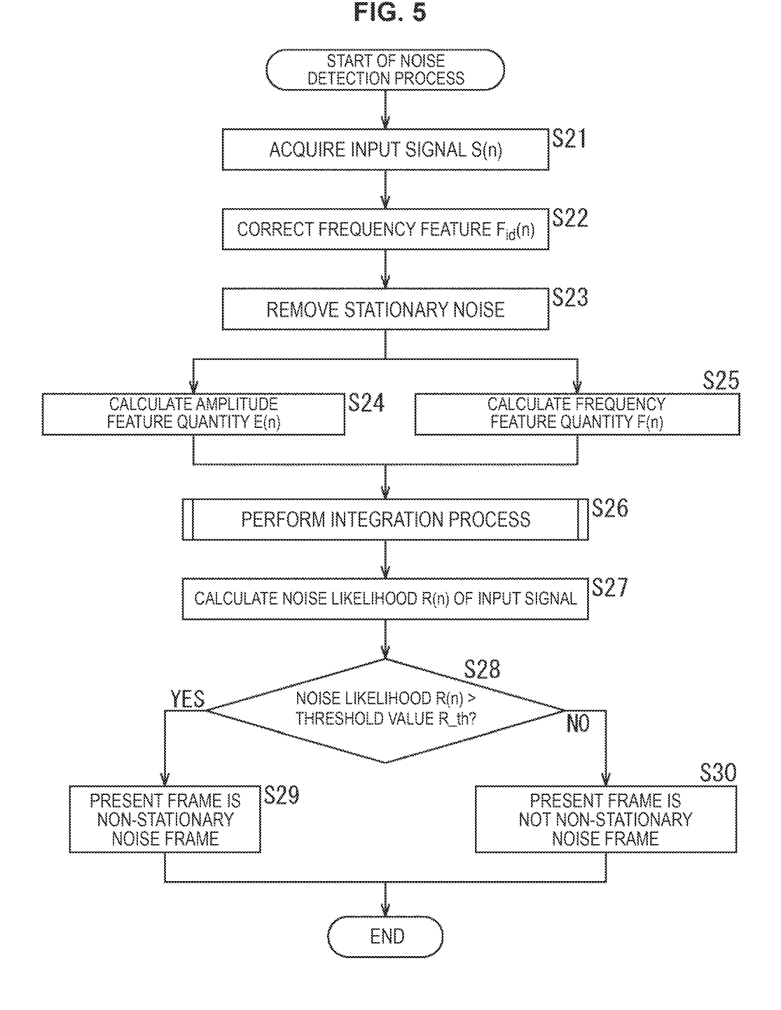

Next, an example of the noise detection process of the noise detection device 100 will be described with reference to the flowchart of FIG. 5.

In step S21, the frequency feature corrector 101 acquires an input signal S(n) that is output from the signal input unit 51.

In step S22, the frequency feature corrector 101 corrects a unique frequency feature F_{id}(n) of the signal input unit 51. At this time, for example, the unique frequency feature is corrected as described above with reference to FIG. 2, and the influence of the unique frequency feature of the signal input unit 51 is removed from the input signal.

In step S23, the stationary noise reducing unit 102 removes stationary noise. Therefore, for example, a driving sound of the noise detection device 100, the signal input unit 51, or the signal processor 52, an air conditioning sound in a conference room, and the like are removed.

In step S24, the amplitude feature quantity calculator 104 calculates an amplitude feature quantity from the input signal supplied from the stationary noise reducing unit 102. At this time, at least one of the above-described E₁(n), E₂(n), and E₃(n) is calculated as an amplitude feature quantity of a frame n.

In step S25, the frequency feature quantity calculator 105 calculates a frequency feature quantity from the input signal supplied from the stationary noise reducing unit 102. At this time, at least one of the above-described F₁(n), F₂(n), F₃(n), and F₄(n) is calculated as a frequency feature quantity of the frame n.

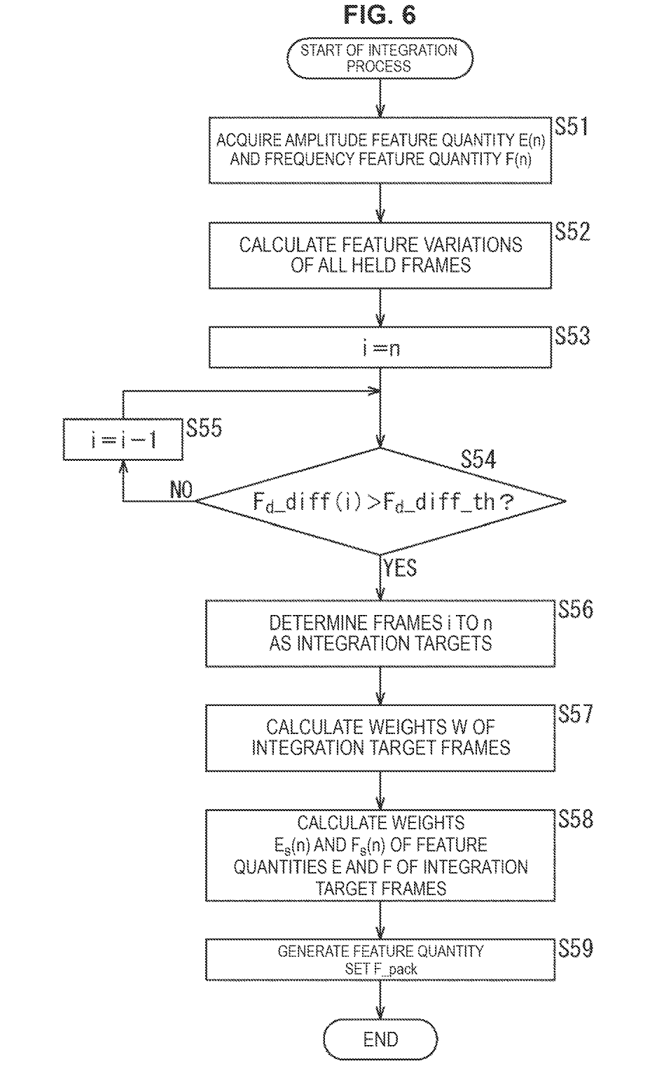

In step S26, the frame integration unit 106 performs an integration process to be described later with reference to FIG. 6. Therefore, the amplitude feature quantities and the frequency feature quantities of a predetermined number of frames, calculated in the process of step S24 and calculated in the process of step S25, respectively, are integrated, and a weighted average value E_{S}(n) of the amplitude feature quantities and a weighted average value F_{S}(n) of the frequency feature quantities are calculated. A set of the weighted average value E_{S}(n) of the amplitude feature quantities and the weighted average value F_{S}(n) of the frequency feature quantities is output as a feature quantity set F_pack.

In step S27, the likelihood calculator 107 calculates a noise likelihood of the input noise. At this time, as described above, a ratio of a threshold value E_th corresponding to the amplitude feature quantity and a ratio of a threshold value F_th corresponding to the frequency feature quantity, to each feature quantity included in the feature quantity set F_pack, are calculated. In addition, the ratios R_{E}(n) and R_{F}(n) are multiplied by preset weights A_{E} and A_{F}, respectively, to calculate a weighted sum. The weighted sum is set as a noise likelihood R(n) corresponding to the n-th frame of the input signal.

In step S28, the noise detector 108 determines whether the noise likelihood R(n) is greater than a noise likelihood threshold value R_th.

In step S28, when it is determined that the noise likelihood R(n) is greater than the noise likelihood threshold value R_th, the process is allowed to proceed to step S29.

In step S29, the noise detector 108 determines whether the n-th frame of the input signal is a non-stationary noise frame.

On the other hand, in step S28, when the noise likelihood R(n) is not greater than the noise likelihood threshold value R_th, the process is allowed to proceed to step S30.

In step S30, the noise detector 108 determines that the n-th frame of the input signal is not a non-stationary noise frame.

Thus, the noise detection process is performed.

Next, a detailed example of the integration process in step S26 of FIG. 5 will be described with reference to the flowchart of FIG. 6.

In step S51, the integration target determination unit 122 acquires amplitude feature quantities and frequency feature quantities held in the feature holding unit 121.

In step S52, the integration target determination unit 122 uses any one feature quantity F_{d} among the amplitude feature quantities and the frequency feature quantities acquired in step S51 to calculate a feature variation F_{d—}diff representing a variation in the feature quantity between frames of the feature quantity. Feature variations F_{d—}diff of all of the frames corresponding to the amplitude feature quantities and the frequency feature quantities held in the feature holding unit 121 are calculated.

For example, when the feature holding unit 121 holds E₁(n), E₂(n), E₃(n), F₁(n), F₂(n), F₃(n), and F₄(n), a feature variation F_{d—}diff(i) representing a variation between an amplitude feature quantity E₃(i−1) of an i−1-th frame and an amplitude feature quantity E₃(i) of an i-th frame is calculated using E₃(n).

In step S53, the integration target determination unit 122 sets a number n representing a current frame as a variable i.

In step S54, the integration target determination unit 122 compares the feature variation F_{d—}diff(i) with a previously set threshold value F_{d—}diff_th to determine whether the feature variation F_{d—}diff(i) exceeds the threshold value F_{d—}diff_th.

In step S54, when it is determined that the feature variation F_{d—}diff(i) does not exceed the threshold value F_{d—}diff_th, the process is allowed to proceed to Step S55.

In step S55, the variable i is decremented and the process returns to step S54.

On the other hand, in step S54, when it is determined that the feature variation F_{d—}diff(i) exceeds the threshold value F_{d—}diff_th, the process is allowed to proceed to step S56.

In step S56, the integration target determination unit 122 determines i-th (frame i) to n-th (frame n) frames as integration targets. In this case, the frame i is an integration target start frame.

In step S57, using a feature quantity F_{w} among the feature quantities held in the feature holding unit 121, the weight calculator 123 calculates a weight based on a difference or a ratio between a feature quantity F_{w} of the current frame and a feature quantity F_{w} of another frame that is an integration target. The feature quantity F_{w} used by the weight calculator 123 may be the same as or different from the feature quantity F_{d} used by the integration target determination unit 122.

The weight calculated by the weight calculator 123 is supplied to the integration unit 124.

The integration unit 124 calculates a weighted average value E_{S}(n) of the amplitude feature quantities through Expression (14) using the weight supplied from the weight calculator 123.

In step S58, the integration unit 124 calculates the weighted average value E_{S}(n) of the amplitude feature quantities and the weighted average value F_{S}(n) of the frequency feature quantities using the weight calculated by the process of step S57.

In step S59, the integration unit 124 generates a set of the weighted average value E_{S}(n) of the amplitude feature quantities and the weighted average value F_{S}(n) of the frequency feature quantities as a feature quantity set F_pack.

Thus, the integration process is performed.

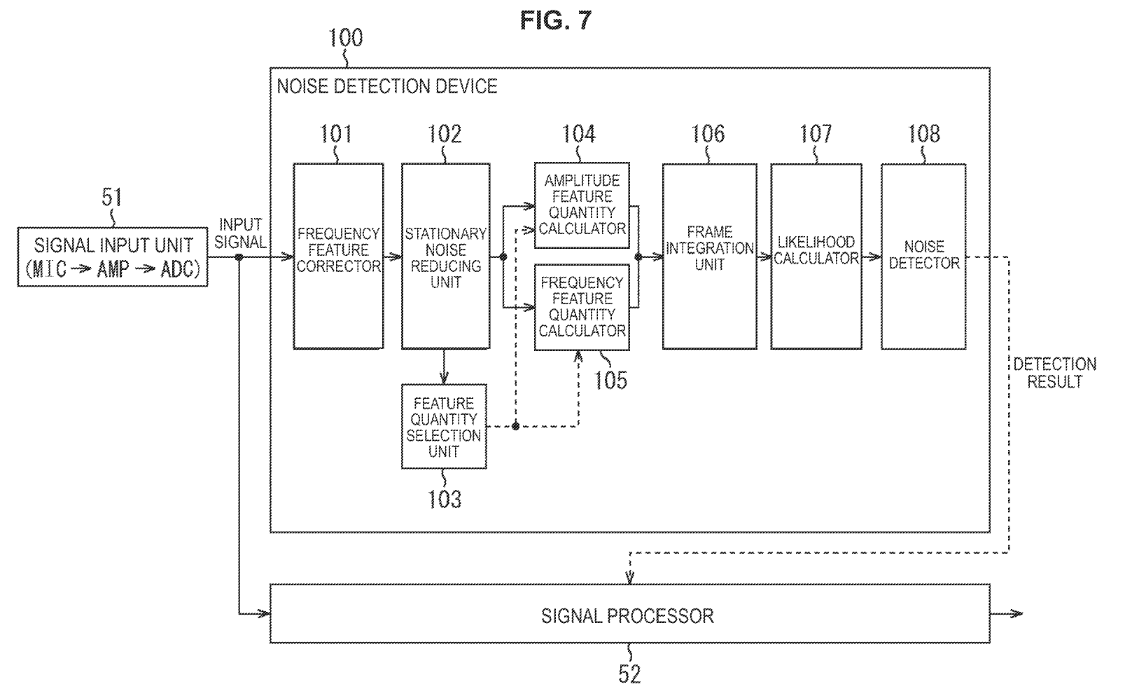

FIG. 7 is a block diagram illustrating an example of a configuration according to another embodiment of the noise detection device 100 to which the present technology is applied. In the configuration of FIG. 7, the noise detection device 100 is provided with a feature quantity selection unit 103, differently from the case of FIG. 1. The remaining configurations of the noise detection device 100 of FIG. 7 are the same as those of the case of FIG. 1.

The feature quantity selection unit 103 specifies an amplitude feature quantity to be calculated by the amplitude feature quantity calculator 104 and a frequency feature quantity to be calculated by the frequency feature quantity calculator 105 based on an input signal that is output through the process of the stationary noise reducing unit 102. Therefore, the calculation load of the amplitude feature quantity calculator 104 and the frequency feature quantity calculator 105 can be reduced.

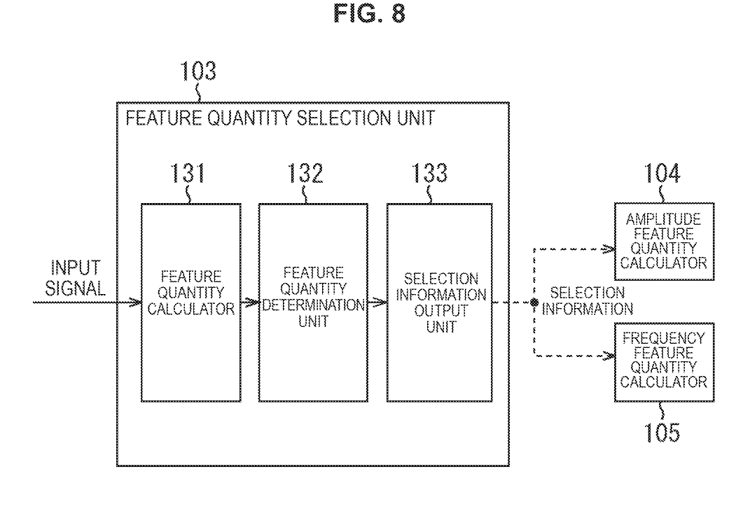

FIG. 8 is a block diagram illustrating a detailed example of a configuration of the feature quantity selection unit 103. As illustrated in FIG. 8, the feature quantity selection unit 103 includes a feature quantity calculator 131, a feature quantity determination unit 132, and a selection information output unit 133.

The feature quantity calculator 131 calculates a feature quantity of an input signal and supplies the calculated feature quantity to the feature quantity determination unit 132. The feature quantity calculated by the feature quantity calculator 131 is, for example, one of the above-described amplitude feature quantities E₁(n), E₂(n), and E₃(n), or the above-described frequency feature quantities F₁(n), F₂(n), F₃(n), and F₄(n).

The feature quantity determination unit 132 compares the feature quantity supplied from the feature quantity calculator 131 with a threshold value. From the result thereof, a feature type of the input signal of the present frame is determined, and the feature type is supplied to the selection information output unit 133.

The selection information output unit 133 selects feature selection information corresponding to each feature type using the feature type supplied from the feature quantity determination unit 132, and the feature selection information is output to the amplitude feature quantity calculator 104 and the frequency feature quantity calculator 105. Here, the feature selection information is information specifying an amplitude feature quantity to be calculated by the amplitude feature quantity calculator 104 and a frequency feature quantity to be calculated by the frequency feature quantity calculator 105.

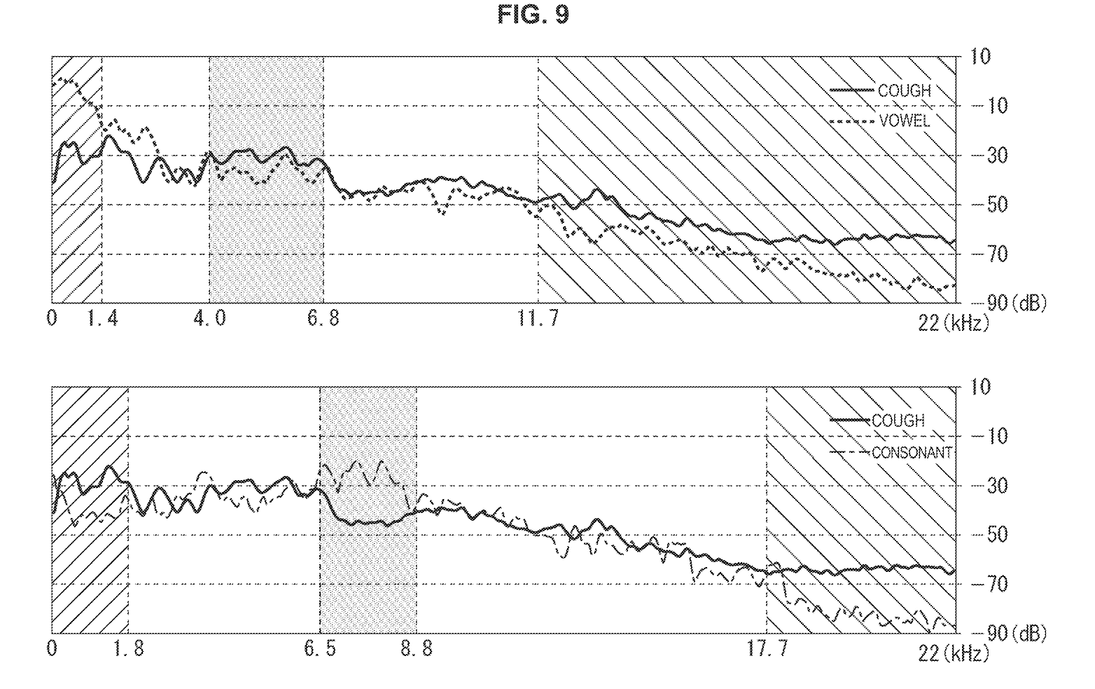

FIG. 9 is a diagram for describing a frequency feature of a cough that is one non-stationary noise, and is a diagram illustrating an example of the comparison in the frequency feature between a cough and a vowel and between a cough and a consonant. In FIG. 9, a horizontal axis represents frequency, and a vertical axis represents a sound pressure level. A frequency feature related to a cough voice and a frequency feature related to a normal speaking voice are shown by a polygonal line. In the upper part of FIG. 9, frequency features of a vowel voice and a cough voice are shown, and in the lower part of FIG. 9, frequency features of a consonant voice and a cough voice are shown.

As illustrated in the upper part of FIG. 9, when a cough voice and a vowel voice are compared, the sound pressure level greatly varies at an interval of 1.4 kHz or less, an interval of from 4 kHz to 6.8 kHz, and an interval of 11.7 kHz or more. That is, when a filter that extracts the frequency feature quantities of these intervals, for example, a frequency band component of 1.4 kHz or less, a frequency band component of from 4 kHz to 6.8 kHz, and a frequency band component of 11.7 kHz or more is used and a set of parameters representing a ratio of the frequency components of the above-described intervals to all of frequency components of the input signal is thereby calculated, it is possible to easily distinguish between the cough voice and the vowel voice.

In addition, as illustrated in the lower part of FIG. 9, when a cough voice and a consonant voice are compared, the sound pressure level greatly varies at an interval of 1.8 kHz or less, an interval of from 6.5 kHz to 8.8 kHz, and an interval of 17.7 kHz or more. That is, using a filter that extracts frequency band components of the intervals in the same manner as in the case of the comparison of the cough voice with the vowel voice, it is possible to easily distinguish between the cough voice and the consonant voice.

However, in the comparison of the cough with the vowel and in the comparison of the cough with the consonant, it is necessary to extract different frequency components, and in order to detect the cough with high accuracy, it is necessary to calculate feature quantities related to a total of about 6 frequency components. That is, when it is not found beforehand that the input signal is a voice closer to a vowel or a voice closer to a consonant, the feature quantity should be calculated while assuming both of the cases.

For example, when it is possible to previously recognize whether the input signal is a voice closer to a vowel or a voice closer to a consonant, it is sufficient to calculate feature quantities related to a total of only about 3 frequency components, and thus the load related to the calculation of the feature quantities can be reduced.

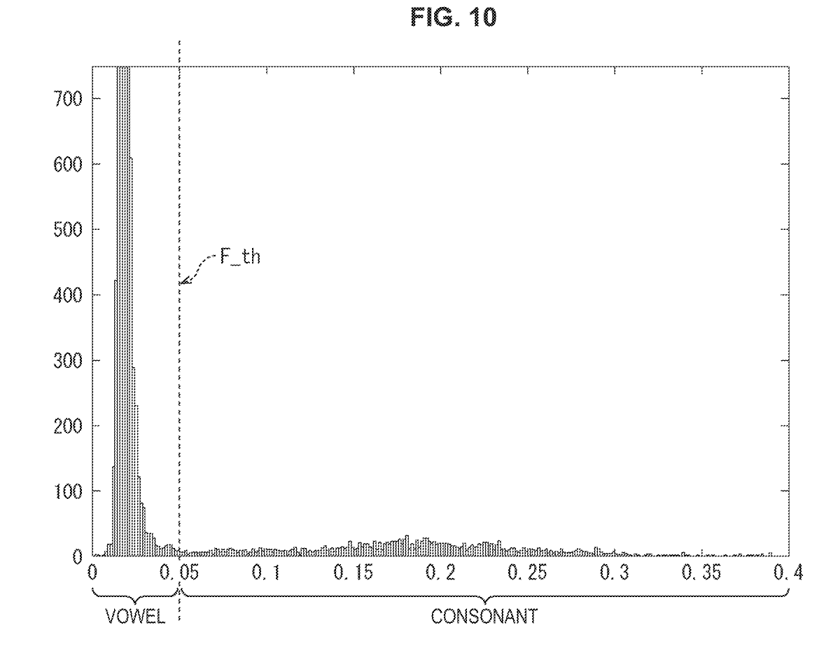

FIG. 10 is a diagram illustrating an example of a distribution of zero crossing rates of voice signals, obtained as a result of a test in which the plurality of voice signals are sampled. In FIG. 10, a horizontal axis represents a zero crossing rate, and a vertical axis represents the number of samples of the voice signals having the zero crossing rate in units of frames.

As illustrated in FIG. 10, in the distribution of the samples, two Gaussian features are shown with a zero crossing rate of 0.05 as a boundary. It is found that most samples having a zero crossing rate of 0.05 or less are vowels. On the other hand, it is found that most samples having a zero crossing rate of 0.05 or more are consonants.

That is, when a zero crossing rate of 0.05 is set as a threshold value F_th and compared with a zero crossing rate of the input signal, it is possible to recognize whether the input signal is a voice closer to a vowel or a voice closer to a consonant.

The feature quantity calculator 131 of the feature quantity selection unit 103 calculates, for example, the zero crossing rate of the input signal, and in the feature quantity determination unit 132, the zero crossing rate of the input signal is compared with the threshold value F_th, and from the result thereof, it is determined whether the feature type of the input signal of the present frame is a vowel or a consonant. Therefore, the amplitude feature quantity to be calculated by the amplitude feature quantity calculator 104 and the frequency feature quantity to be calculated by the frequency feature quantity calculator 105 become feature quantities for a vowel or a consonant.

By providing the feature quantity selection unit 103 as described above, the calculation load of the amplitude feature quantity calculator 104 and the frequency feature quantity calculator 105 can be reduced.

Here, the example in which the feature quantity selection unit 103 determines whether the feature type of the input signal of the present frame is a vowel or a consonant has been described. However, for example, it may be determined whether the feature type of the input signal of the present frame is a type having a high sound pressure (high sound pressure) or a type having a low sound pressure (low sound pressure). For example, in the case of low sound pressure (when the volume is low), it is difficult to obtain a favorable S/N feature, and thus a feature quantity having little influence on the stationary noise may be selected.

In this case, it is also possible to determine the feature type of the input signal of the present frame by comparing, in place of the zero crossing rate, an amplitude feature quantity (E₂(n)) representing an average value of L sample values included in a frame n or an amplitude feature quantity (E₃(n)) representing an RMS value of the L sample values included in the frame n with the threshold value.

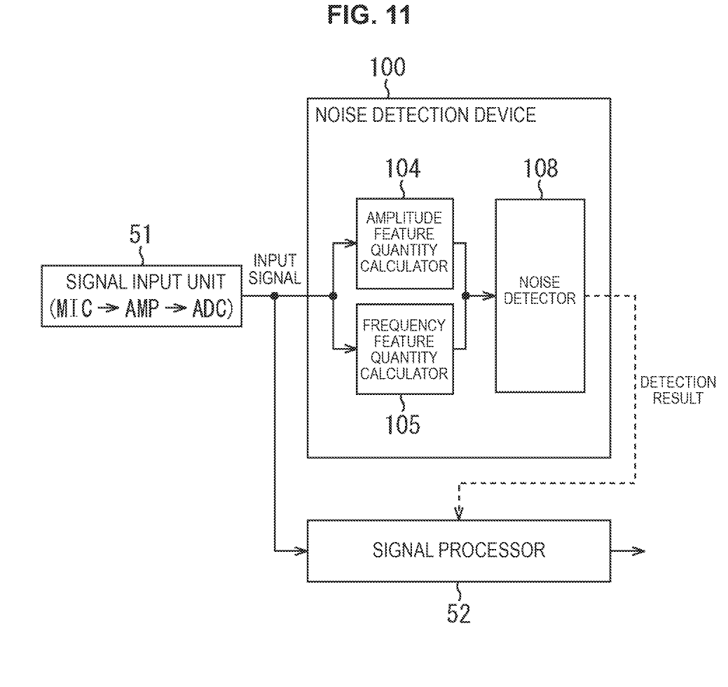

FIG. 11 is a block diagram illustrating an example of a configuration according to a further embodiment of the noise detection device 100 to which the present technology is applied. In the configuration of FIG. 11, the noise detection device 100 is not provided with the frequency feature corrector 101, the stationary noise reducing unit 102, the frame integration unit 106, and the likelihood calculator 107, differently from the case of FIG. 1. The remaining configurations of the noise detection device 100 of FIG. 11 are the same as those of the case of FIG. 1.

In the case of the configuration of FIG. 11, the noise detection device 100 directly calculates an amplitude feature quantity and a frequency feature quantity from an input signal supplied from the signal input unit 51, and determines whether the present frame is a non-stationary noise frame by directly using the amplitude feature quantity and the frequency feature quantity. In this case, the noise detector 108 subjects each of the amplitude feature quantity and the frequency feature quantity to threshold value determination, and determines whether the present frame is a non-stationary noise frame in accordance with the determination result.

Otherwise, a configuration can also be employed in which one to three of the frequency feature corrector 101, the stationary noise reducing unit 102, the frame integration unit 106, and the likelihood calculator 107 are additionally mounted on the noise detection device 100 illustrated in FIG. 11.

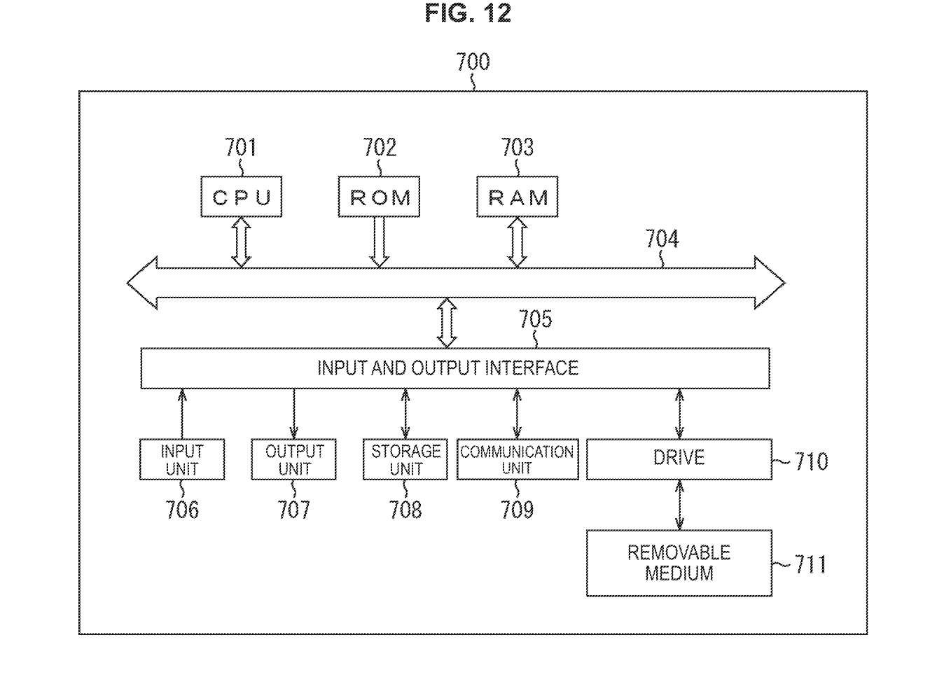

The above-described series of processes can be executed by hardware or software. When the above-described series of processes is executed by software, a program of the software is installed on a computer built in dedicated hardware, a general-purpose personal computer 700 illustrated in FIG. 12 that can execute various functions through the installation of various programs, or the like from a network or a recording medium.

In FIG. 12, a central processing unit (CPU) 701 executes various processes in accordance with a program stored in a read only memory (ROM) 702 or a program loaded from a storage unit 708 to a random access memory (RAM) 703. Data necessary for execution of various processes by the CPU 701 is also appropriately stored in the RAM 703.

The CPU 701, the ROM 702, and the RAM 703 are connected to each other via a bus 704. An input and output interface 705 is also connected to the bus 704.

An input unit 706 including a keyboard, a mouse, and the like, an output unit 707 including a display formed of a liquid crystal display (LCD) or the like, a speaker, and the like, the storage unit 708 including a hard disk, and a communication unit 709 including a modem, a network interface card such as a LAN card, and the like are connected to the input and output interface 705. The communication unit 709 performs a communication process via a network including the Internet.

If necessary, a drive 710 is connected to the input and output interface 705, and a removable medium 711 such as a magnetic disk, an optical disc, a magneto-optical disc, or a semiconductor memory is appropriately mounted. A computer program read out therefrom is installed in the storage unit 708, as necessary.

When the above-described series of processes is executed by software, a program of the software is installed from a network such as the Internet or a recording medium formed of a removable medium 711.

This recording medium may be constituted by the removable medium 711 shown in FIG. 12, that is provided to distribute programs to a user separately from the device body, and that is formed of a magnetic disk (including a floppy disk (registered trade name)), an optical disc (including a compact disc-read only memory (CD-ROM) and a digital versatile disc (DVD)), a magneto-optical disc (including mini disk (MD) (registered trade name)), a semiconductor memory, or the like. Alternatively, such a medium may be constituted by the ROM 702 in which programs are recorded, the hard disk included in the storage unit 708, or the like, which is provided to a user beforehand in a state in which this medium is built in the device body.

In the present disclosure, the series of processes includes a process that is executed in the order described, but the process is not necessarily executed temporally and can be executed in parallel or individually.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)
A noise detection device including:

an amplitude feature quantity calculator that calculates an amplitude feature quantity in a waveform of a predetermined frame of an input signal of a voice;

a frequency feature quantity calculator that calculates a frequency feature quantity in the waveform of the predetermined frame;

a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;

an interval specification unit that compares the feature variation with a previously set threshold value to specify an interval of temporarily continuous frames in which the amplitude feature quantities and the frequency feature quantities held in the holding unit are to be subjected to weighted averaging;

a feature quantity set generation unit that generates, as a feature quantity set, a set of respective weighted average values of the amplitude feature quantities and the frequency feature quantities corresponding to each of the frames of the specified interval; and

a noise determination unit that determines whether a latest frame of the input signal is a frame including non-stationary noise that is sudden noise based on the feature quantity set.

(2)
The noise detection device according to (1),

wherein the amplitude feature quantity calculator or the frequency feature quantity calculator calculates at least two types of amplitude feature quantities among a plurality of types of amplitude feature quantities or a plurality of types of frequency feature quantities, and

wherein a feature quantity selection unit that selects an amplitude feature quantity to be calculated by the amplitude feature quantity calculator among the plurality of types of amplitude feature quantities, or a frequency feature quantity to be calculated by the frequency feature quantity calculator among the plurality of types of frequency feature quantities, based on a zero crossing rate of the input signal of the predetermined frame, an average value of a plurality of sample values of the input signal of the predetermined frame, or an RMS value of the plurality of sample values of the input signal of the predetermined frame, is further provided.

(3)
The noise detection device according to (2),

wherein the feature quantity selection unit determines whether the input signal of the predetermined frame is closer to a vowel or a consonant based on the zero crossing rate of the input signal of the predetermined frame, and selects, in accordance with the determination result, the amplitude feature quantity to be calculated by the amplitude feature quantity calculator and the frequency feature quantity to be calculated by the frequency feature quantity calculator among the plurality of types of frequency feature quantities.

(4)
The noise detection device according to any one of (1) to (3),

wherein the amplitude feature quantity calculator calculates, as the amplitude feature quantity, at least one of a peak value of a plurality of sample values of the predetermined frame, an average value of the plurality of sample values of the predetermined frame, and an RMS value of the plurality of sample values of the predetermined frame, and

wherein the frequency feature quantity calculator calculates, as the frequency feature quantity, at least one of a zero crossing rate of the input signal of the predetermined frame, a ratio of a sound pressure of a specific frequency component to sound pressures of all of frequency components in the input signal of the predetermined frame, a ratio of the sound pressure of the specific frequency component to a sound pressure of a frequency component differing from the specific frequency component in the input signal of the predetermined frame, and one or more specific values among frequency spectra obtained by a Fourier transform of the input signal of the predetermined frame.

(5)
The noise detection device according to any one of (1) to (4),

wherein the noise determination unit calculates a ratio of a weighted average value of the amplitude feature quantities included in the feature quantity set and a previously set first value, and a ratio of a weighted average value of the frequency feature quantities and a previously set second value, calculates a noise likelihood based on the calculated ratios, and compares the noise likelihood with a previously set threshold value to determine whether the latest frame of the input signal is a frame including the non-stationary noise.

(6)
The noise detection device according to any one of (1) to (5),

wherein the noise determination unit calculates a noise likelihood, representing certainty of a determination that a present frame is a non-stationary noise frame, from a feature vector corresponding to the feature quantity set based on a previously learned identification model in a feature vector space using some or all of the weighted average values of the amplitude feature quantities and the weighted average values of the frequency feature quantities included in the feature quantity set, and compares the noise likelihood with a previously set threshold value to determine whether the latest frame of the input signal is a frame including the non-stationary noise.

(7)
The noise detection device according to any one of (1) to (6), further including:

a frequency feature corrector that corrects a frequency feature of a signal input device that supplies the input signal.

(8)
The noise detection device according to any one of (1) to (7), further including:

a stationary noise removing unit that removes, from the input signal, stationary noise that is noise differing from the non-stationary noise.

(9)
A noise detection method including:

calculating, by an amplitude feature quantity calculator, an amplitude feature quantity in a waveform of a predetermined frame of an input signal of a voice;

calculating, by a frequency feature quantity calculator, a frequency feature quantity in the waveform of the predetermined frame;

calculating, by a feature variation calculator, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;

comparing, by an interval specification unit, the feature variation with a previously set threshold value to specify an interval of temporarily continuous frames in which the amplitude feature quantities and the frequency feature quantities held in the holding unit are to be subjected to weighted averaging;

generating, by a feature quantity set generation unit, as a feature quantity set, a set of respective weighted average values of the amplitude feature quantities and the frequency feature quantities corresponding to each of the frames of the specified interval; and

determining, by a noise determination unit, whether a latest frame of the input signal is a frame including non-stationary noise that is sudden noise based on the feature quantity set.

(10)
A program causing a computer to function as a noise detection device including:

an amplitude feature quantity calculator that calculates an amplitude feature quantity in a waveform of a predetermined frame of an input signal of a voice;

a frequency feature quantity calculator that calculates a frequency feature quantity in the waveform of the predetermined frame;

a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;

an interval specification unit that compares the feature variation with a previously set threshold value to specify an interval of temporarily continuous frames in which the amplitude feature quantities and the frequency feature quantities held in the holding unit are to be subjected to weighted averaging;

a feature quantity set generation unit that generates, as a feature quantity set, a set of respective weighted average values of the amplitude feature quantities and the frequency feature quantities corresponding to each of the frames of the specified interval; and

a noise determination unit that determines whether a latest frame of the input signal is a frame including non-stationary noise that is sudden noise based on the feature quantity set.

What is claimed is:

1. A noise detection device comprising:
an amplitude feature quantity calculator that calculates an amplitude feature quantity in a waveform of a predetermined frame of an input signal of a voice;
a frequency feature quantity calculator that calculates a frequency feature quantity in the waveform of the predetermined frame;
a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;
an interval specification unit that compares the feature variation with a previously set threshold value to specify an interval of temporarily continuous frames in which the amplitude feature quantities and the frequency feature quantities held in the holding unit are to be subjected to weighted averaging;
a feature quantity set generation unit that generates, as a feature quantity set, a set of respective weighted average values of the amplitude feature quantities and the frequency feature quantities corresponding to each of the frames of the specified interval; and
a noise determination unit that determines whether a latest frame of the input signal is a frame including non-stationary noise that is sudden noise based on the feature quantity set.

2. The noise detection device according to claim 1,
wherein the amplitude feature quantity calculator or the frequency feature quantity calculator calculates at least two types of amplitude feature quantities among a plurality of types of amplitude feature quantities or a plurality of types of frequency feature quantities, and
wherein a feature quantity selection unit that selects an amplitude feature quantity to be calculated by the amplitude feature quantity calculator among the plurality of types of amplitude feature quantities, or a frequency feature quantity to be calculated by the frequency feature quantity calculator among the plurality of types of frequency feature quantities, based on a zero crossing rate of the input signal of the predetermined frame, an average value of a plurality of sample values of the input signal of the predetermined frame, or an RMS value of the plurality of sample values of the input signal of the predetermined frame, is further provided.

3. The noise detection device according to claim 2,
wherein the feature quantity selection unit determines whether the input signal of the predetermined frame is closer to a vowel or a consonant based on the zero crossing rate of the input signal of the predetermined frame, and selects, in accordance with the determination result, the amplitude feature quantity to be calculated by the amplitude feature quantity calculator and the frequency feature quantity to be calculated by the frequency feature quantity calculator among the plurality of types of frequency feature quantities.

4. The noise detection device according to claim 1,
wherein the amplitude feature quantity calculator calculates, as the amplitude feature quantity, at least one of a peak value of a plurality of sample values of the predetermined frame, an average value of the plurality of sample values of the predetermined frame, and an RMS value of the plurality of sample values of the predetermined frame, and
wherein the frequency feature quantity calculator calculates, as the frequency feature quantity, at least one of a zero crossing rate of the input signal of the predetermined frame, a ratio of a sound pressure of a specific frequency component to sound pressures of all of frequency components in the input signal of the predetermined frame, a ratio of the sound pressure of the specific frequency component to a sound pressure of a frequency component differing from the specific frequency component in the input signal of the predetermined frame, and one or more specific values among frequency spectra obtained by a Fourier transform of the input signal of the predetermined frame.

5. The noise detection device according to claim 1,
wherein the noise determination unit calculates a ratio of a weighted average value of the amplitude feature quantities included in the feature quantity set and a previously set first value, and a ratio of a weighted average value of the frequency feature quantities and a previously set second value, calculates a noise likelihood based on the calculated ratios, and compares the noise likelihood with a previously set threshold value to determine whether the latest frame of the input signal is a frame including the non-stationary noise.

6. The noise detection device according to claim 1,
wherein the noise determination unit calculates a noise likelihood, representing certainty of a determination that a present frame is a non-stationary noise frame, from a feature vector corresponding to the feature quantity set based on a previously learned identification model in a feature vector space using some or all of the weighted average values of the amplitude feature quantities and the weighted average values of the frequency feature quantities included in the feature quantity set, and compares the noise likelihood with a previously set threshold value to determine whether the latest frame of the input signal is a frame including the non-stationary noise.

7. The noise detection device according to claim 1, further comprising:
a frequency feature corrector that corrects a frequency feature of a signal input device that supplies the input signal.

8. The noise detection device according to claim 1, further comprising:
a stationary noise removing unit that removes, from the input signal, stationary noise that is noise differing from the non-stationary noise.

9. A noise detection method comprising:
calculating, by an amplitude feature quantity calculator, an amplitude feature quantity in a waveform of a predetermined frame of an input signal of a voice;
calculating, by a frequency feature quantity calculator, a frequency feature quantity in the waveform of the predetermined frame;
calculating, by a feature variation calculator, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;
comparing, by an interval specification unit, the feature variation with a previously set threshold value to specify an interval of temporarily continuous frames in which the amplitude feature quantities and the frequency feature quantities held in the holding unit are to be subjected to weighted averaging;
generating, by a feature quantity set generation unit, as a feature quantity set, a set of respective weighted average values of the amplitude feature quantities and the frequency feature quantities corresponding to each of the frames of the specified interval; and
determining, by a noise determination unit, whether a latest frame of the input signal is a frame including non-stationary noise that is sudden noise based on the feature quantity set.

10. A program causing a computer to function as a noise detection device comprising:
an amplitude feature quantity calculator that calculates an amplitude feature quantity in a waveform of a predetermined frame of an input signal of a voice;
a frequency feature quantity calculator that calculates a frequency feature quantity in the waveform of the predetermined frame;
a feature variation calculator that calculates, based on one feature quantity among the amplitude feature quantities and the frequency feature quantities held in a holding unit that holds the amplitude feature quantities and the frequency feature quantities of a plurality of frames, a feature variation that is a variation in the feature quantity between two temporarily adjacent frames;
an interval specification unit that compares the feature variation with a previously set threshold value to specify an interval of temporarily continuous frames in which the amplitude feature quantities and the frequency feature quantities held in the holding unit are to be subjected to weighted averaging;
a feature quantity set generation unit that generates, as a feature quantity set, a set of respective weighted average values of the amplitude feature quantities and the frequency feature quantities corresponding to each of the frames of the specified interval; and
a noise determination unit that determines whether a latest frame of the input signal is a frame including non-stationary noise that is sudden noise based on the feature quantity set.
